(19) United States
(12) Patent Application Publication
(10) Pub. No.: US 2007/0079972 A1
(43) Pub. Date: Apr. 12, 2007

(54) Manually activated, portable fire-extinguishing aerosol generator

(75) Inventor: Marc V. Gross, Shorewood, MN (US)

Correspondence Address: SCHWEGMAN, LUNDBERG, WOESSNER & KLUTH, P.A., P.O. BOX 2938, MINNEAPOLIS, MN, 55402, US

(73) Assignee: FIREAWAY LLC, Minnetonka, MN (US)

(21) Appl. No.: 11/234,625

(22) Filed: Sep. 23, 2005

(51) Int. Cl. A62C 2/00; A62C 3/00

(52) U.S. Cl. 169/46; 169/75; 169/85; 169/89

(57) ABSTRACT

Manually activated, portable aerosol fire extinguisher includes a casing having opposed end walls and discharge ports in each end wall, an arrangement for generating fire suppression agent to be discharged through the discharge ports, and an activation system which enables manual activation of the generating arrangement at a safe location a distance from a fire. The activation system includes a firing pin which causes ignition of igniter material upon contact with a primer thereof, a delay column arranged between the primer and igniter material to delay ignition of the igniter material, a safety lever which normally prevents the firing pin from contacting the primer and a manually releasable pull pin which maintains the safety lever in a position preventing the firing pin from contacting the primer. Upon release of the pull pin, the firing pin contacts the primer causing generation of the fire suppression agent.

### FIELD OF THE INVENTION

The present invention relates generally to a fire-extinguishing aerosol generator and more specifically to a manually activated, portable fire-extinguishing aerosol generator designed to be thrown or otherwise introduced from a relatively safe location into a fire in an enclosed volume and discharge a fire suppression agent once in the enclosed volume to thereby extinguish the fire.

The present invention also relates to a method for extinguishing a fire in an enclosed volume using a portable aerosol generator.

### BACKGROUND OF THE INVENTION

Self-contained aerosol generators are often used to extinguish fires in enclosed volumes. The generators are usually mounted within the boundaries defining the enclosed volume and automatically activated electronically by means of remote sensing devices coupled to an electronic releasing panel which sends a signal activating the aerosol generator upon the sensing of a fire. Upon activation, the generators generate a quantity of an aerosol fire suppression agent which disperses into the enclosed volume and chemically interferes with fire propagating radicals thereby interrupting the fire reaction.

A conventional aerosol generator includes a casing which is mounted to a wall or other structure by means of a fixed bracket and includes discharge ports. To generate the aerosol fire suppression agent, a combustible aerosol-forming compound is arranged in the casing. The internal space above the aerosol-forming compound defines a combustion chamber which may be followed by structural elements which oxidize and/or cool the aerosol as it is discharged from the unit. Igniter material is arranged in connection with the aerosol-forming compound to cause combustion thereof and is ignited by receipt of an electronic signal from a releasing panel initiated by a remotely located sensor upon detection of a fire in the enclosed volume. Upon ignition of the igniter material, combustion of the aerosol-forming compound occurs resulting in dispersion of the aerosol fire suppression agent through the discharge ports in a manner known to those skilled in the art.

Aerosol generators are often incorporated into a system which includes fire-sensing devices spaced around the enclosed volume and a releasing panel which monitors the integrity of the system and activates the generators upon notification of a fire by means of a signal received from one or more of the sensing devices. Instead of remote fire-sensing devices, some aerosol generators include a thermal sensor arranged directly on the generator, however, these are used primarily for very small volumes such as within an electronic cabinet.

A drawback of fixedly mounting such aerosol generators is that they cannot be easily moved in a timely fashion to extinguish a fire from a different location than the mounting location. Thus, if an aerosol generator is arranged in one room of a facility and a fire is present in another room, the aerosol generator cannot be readily removed from the room without the fire, moved to the room with the fire and activated therein. In fact, removal of an aerosol generator from its mounting location for use at another location is not even worthwhile because most are electronically activated and therefore would not activate in a safe or timely manner if thrown into a fire. As such, conventional aerosol generators are not considered portable apparatus.

However, a portable aerosol generator is known, namely an aerosol fire extinguisher designated FP-1000M and sold by Celanova Ltd. under the tradename FirePro. This aerosol generator is manually activated by pulling a safety pin which results in immediate combustion of an aerosol-forming compound. This aerosol generator is susceptible to causing injury to users since it does not appear to include a handle, safety lever or other mechanism which allows for a time delay between pulling the safety pin and combustion of the aerosol-forming compound. Also, this aerosol generator is dangerous because it does not include any provision for cooling the discharge or for acting as a spark/flame arrestor.

There are additional serious drawbacks to this portable aerosol generator, as well as to other known portable aerosol generators. For example, the aerosol generators utilize aerosol-forming compounds that may produce high levels of toxic gases and burn at high temperatures, i.e., about 1700°, they are not structured to and do not include material to cool the aerosol before it is discharged from the casing and often produce a flame out of the discharge ports which is itself a potential ignition source, they are not sealed allowing the aerosol-forming compound to deteriorate over time from exposure to humidity, and there is no time delay upon actuation. As to the last point, the aerosol generators are typically activated by a mechanical activator that engages immediately upon pulling a pull ring, thus exposing the user to the high temperature discharge products. Another potential drawback is that the discharge ports are arranged on only one side of the casing resulting in the possibility of discharge of the fire suppression agent being inhibited if oriented with the discharge ports facing a wall, as well as imparting thrust to the casing.

Accordingly, it would be desirable to provide a portable aerosol generator which avoids the drawbacks of prior art portable aerosol generators.

### OBJECTS AND SUMMARY OF THE INVENTION

It is an object of the present invention to provide a new and improved portable fire extinguisher, namely, a portable aerosol generator.

It is another object of the present invention to provide a new portable fire extinguisher which can be easily moved to a desired activation location, i.e., an enclosed volume with a fire therein, and manually activated when at that location.

It is yet another object of the present invention to provide a new portable fire extinguisher which can be safely thrown or otherwise introduced into a fire in an enclosed volume and activated upon being thrown or introduced to thereby generate a fire suppression agent which extinguishes the fire. This can be achieved with a time delay mechanism.

It is still another object of the present invention to provide a new method for extinguishing a fire using a portable aerosol generator.

It is yet another object of the present invention to provide a new and improved fire extinguisher having a combustion chamber defined in part by a cooling bed/spark arrester block thereby eliminating the discharge of high temperature combustion products.

Another object of the present invention is to provide a new and improved fire extinguisher having an arrangement of discharge ports which minimizes or even eliminates thrust generated upon discharge of fire suppression agent therefrom.

In order to achieve these objects and others, an apparatus for extinguishing a fire in accordance with the invention includes an elongate casing having opposed end walls and at least one discharge port formed in each end wall, an arrangement of one or more materials in the casing capable of generating an aerosol fire suppression agent which is discharged through discharge ports in both end walls and a manual activation system which enables manual activation of the fire suppression agent generating arrangement at a relatively safe location and distance from the fire. The casing can thus be thrown or otherwise introduced into the fire upon the manual activation of the generating arrangement.

The materials for generating the fire suppression agent include a combustible aerosol-forming compound spaced from both end walls of the casing and a block of oxidation and/or cooling material arranged between the aerosol-forming compound and each end wall. The generating arrangement also includes igniter material arranged in connection with the aerosol-forming compound and which is ignited by the manual activation system to cause combustion of the aerosol-forming compound.

The manual activation system includes a firing pin which causes ignition of the igniter material upon contact with a primer thereof, a safety lever or other restraining member which normally restrains or prevents the firing pin from contacting the primer and a manually releasable pull pin arranged to maintain the safety lever in a position in which the firing pin is prevented from contacting the primer. Upon release of the pull pin, the safety lever is urged out of a position in which it prevents contact between the firing pin and the primer, with the result that the firing pin can brought into contact with the primer, thereby causing ignition of the igniter material leading to combustion of the aerosol-forming compound and generation of the fire suppression agent.

A time delay column is interposed between the primer and the igniter material to delay the ignition of the igniter material after release of the pull pin. The magnitude of this time delay is selected to provide a sufficient amount of time between release of the pull pin at a safe distance from the fire and the discharge of the fire suppression agent from the apparatus once the apparatus has been introduced into the fire.

Movement of the firing pin from its restrained position into its contact position may be caused by a spring or other biasing mechanism which biases the firing pin against the safety lever and into contact with the primer. Thus, upon release of the pull pin, the spring causes the firing pin to displace the safety lever and continue its movement until it impacts the primer.

The pull pin and safety lever may be designed to cooperate such that the pull pin can be released only when a part of the safety lever is urged against the casing, to prevent inadvertent release of the pull pin resulting in unwanted activation of the apparatus.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a perspective view of a manually activated, portable fire-extinguishing aerosol generator in accordance with the invention.

FIG. 2 is a cross-sectional view of the aerosol generator shown in FIG. 1 in a position in which it has already been manually activated.

FIG. 3 is an enlarged view of the upper portion of the aerosol generator shown in FIG. 1 shown prior to manual activation.

FIG. 4 is an enlarged view of the upper portion of the aerosol generator shown in FIG. 1 shown with the firing pin in an activation position.

### DETAILED DESCRIPTION OF THE INVENTION

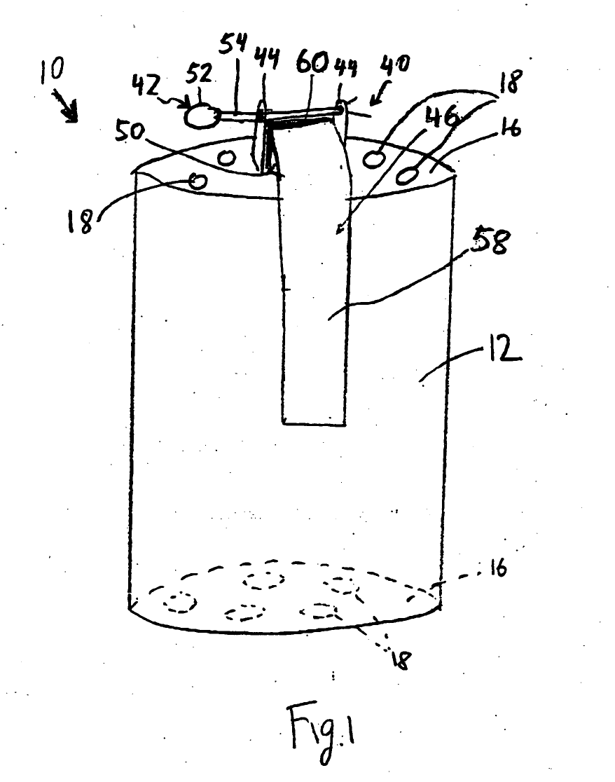

Referring to the accompanying drawings wherein like reference numbers refer to the same or similar objects, FIGS. 1-4 show a manually activated, portable aerosol fire extinguisher in accordance with the invention which is designated generally as 10 and comprises a substantially cylindrical casing 12 having an insulating tube 14 and generally planar end plates or walls 16 each having one or more discharge ports 18 formed therein. Thermal insulation may be provided by the insulating tube 14.

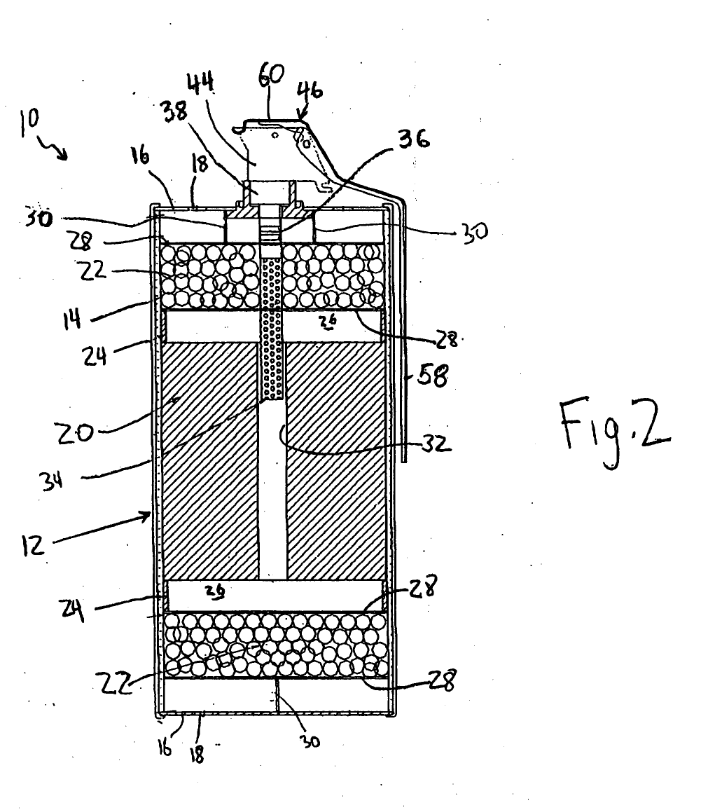

Within insulating tube 14, one or more materials capable of generating aerosol fire suppression agent to be discharged through the discharge ports 18 are provided. For example, as shown in FIG. 2, the insulating tube 14 includes an aerosol-forming compound 20 arranged in the middle of the insulating tube 14 and a block of an oxidation and/or cooling material 22 arranged between the aerosol-forming compound 20 and each end wall 16. Each block of oxidation and/or cooling material 22 may also serve as a spark arrester, i.e., incorporate a spark arresting material. Spacers 24 are arranged between the aerosol-forming compound 20 and each block of oxidation and/or cooling material 22 to define combustion chambers 26 therebetween. To screen the file suppression agent, screen filters 28 are arranged alongside each exposed side of the blocks of oxidation and/or cooling material 22. To support the screen filters 28 facing the end walls 16, spacers 30 are arranged between these screen filters 28 and the end walls 16.

The blocks of oxidation and/or cooling material 22 cool the combustion products of the aerosol-forming compound 20 forming in combustion chambers 26 so that the temperature of the fire suppression agent being discharged through the discharge ports 18 in the end walls 16 is not likely to be an ignition source and will not have a relatively high temperature, in comparison with prior art aerosol generators. The primary function of the combustion chambers 26 is to enhance the burning of the aerosol-forming compound 20 to reduce levels of toxic gas production. Exposure of the aerosol-forming compound 20 to ambient atmosphere and thus deterioration of the aerosol-forming compound 20 caused by humidity is prevented by a nearly impermeable membrane arranged on the inside of the end walls 16 and by the fact that the seams between the insulating tube 14 and the end walls 16 (when crimped closed) are sealed with a sealant that provides a near hermetic seal.

Aerosol-forming compound 20 is formed with an inner channel 32 into which a block of igniter material 34 is placed (see FIG. 2). A time delay column 36 is arranged at the upper end of the block of igniter material 34 and a primer 38 is arranged at the upper end of the delay column 36. The delay column 36 may be a separate component arranged between the primer 38 and the igniter material 34, or part of one of these elements. When impacted, the primer 38 ignites the delay column 36 which in turn ignites the igniter material 34 after a pre-determined delay resulting from the design and/or construction of the delay column 36. The block of igniter material 34 and delay column 36 also extend partially through one of the blocks of oxidation and/or cooling material 22, and are preferably isolated therefrom.

Casing 12 can be constructed with a variety of different sizes and fire suppression agent generating capacities, with the attendant different quantities of aerosol-forming compound 20, oxidation and/or cooling material 22 and igniter material 34.

Possible aerosol-forming compounds for use in the invention include those described in U.S. Pat. Nos. 5,831,209, 6,042,664, 6,264,772 and 6,689,285 (all of which are assigned to R-Amtech International, Inc.), the entire disclosure of each of which is incorporated herein by reference.

In accordance with the invention, the aerosol fire extinguisher 10 includes a manual activation system 40 which requires a manual effort in order to cause ignition of the igniter material 34 resulting in generation of the fire suppression agent and its discharge through the discharge ports 18. By contrast, in prior art aerosol generators, ignition of the igniter material is usually performed automatically upon detection of a fire without any manual effort.

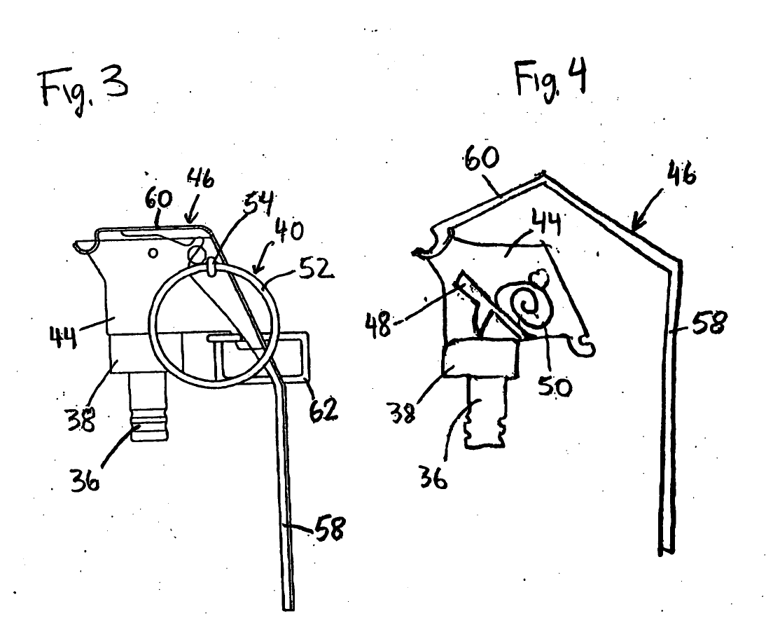

Specifically, the manual activation system 40 includes a manually releasable pull pin 42 which is removably engaged with supports 44 arranged on the outer surface of the upper end wall 16 of the casing 12, a handle or safety lever 46 which is maintained in a position on the casing 12 by the engagement of the pull pin 42 with the supports 44, and a striker or firing pin 48 which is biased against the safety lever 46 by a spring 50 (see FIG. 4). Pull pin 42 includes a pull ring 52 and a safety cotter pin 54 (see FIG. 3). The firing pin 48 is mounted on a mounting projection 56 on the upper end wall 16 of the casing 12 and biased to pivot about the mounting projection 56 into contact with the primer 38. The impact of the firing pin 48 with the primer 38 causes ignition thereof and then ignition of the delay column 36 and the igniter material 34. However, safety lever 46 restrains firing pin 48 in that it prevents firing pin 48 from contacting the primer 38 when safety lever 46 is held in the position on the casing 12 by engagement of the pull pin 42 with the supports 44.

Safety lever 46 has a first part 58 arranged alongside a lateral wall of the casing 12 and a second part 60 arranged above the end wall 16 of the casing 12 and over the mounting projection 56 (see FIG. 2). Instead of safety lever 46, other restraining members which restrain the firing pin 48 when the pull pin 42 is attached to the casing 12 while allowing pivotal movement of the firing pin 48 when the pull pin 42 is detached from the casing 12 can be provided.

As an added safety feature, a rectangular safety clip 62 can be arranged to maintain the safety lever 46 in engagement with the supports 44 (see FIG. 3). Removal of safety clip 62 is necessary in order to enable pivotal movement of the safety lever 46 upon removal of the pull pin 42.

In use, upon removal of the pull pin 42 from engagement with the supports 44, the safety lever 46 can be urged out of its position restraining firing pin 48. The biasing force provided by spring 50 causes the firing pin 48 to pivot about the mounting projection 56 thereby forcing the safety lever 46 away from the casing 12 and out of a position in which it is preventing the firing pin 48 from contacting the primer 38. Upon continued pivoting movement, the firing pin 48 then impacts the primer 38 causing ignition of the delay column 36 and the igniter material 34 which in turn causes combustion of the aerosol-forming compound 20 resulting in generation of the fire suppression agent and its discharge through discharge ports 18.

Thus, to extinguish a fire in an enclosed volume using aerosol fire extinguisher 10, the user would carry the aerosol fire extinguisher 10 to a site in close proximity to the enclosed volume, identify or create an access opening in or to the enclosed volume, e.g., open a door or window leading to the enclosed volume, and remove the safety clip 62 is present. Then, the pull ring 52 is pulled while holding the first part 54 of the safety lever 46 against the casing 12, causing the safety cotter pin 54 to be disengaged from the supports 44. As long as the safety lever 46 is held by the user the firing pin 48 cannot rotate into contact with the primer 38.

The fire extinguisher 10 is then introduced into the enclosed volume, e.g., by throwing the fire extinguisher into the fire. If possible, access to the enclosed volume is blocked, i.e., by closing the door or window. As the fire extinguisher is in its trajectory into the enclosed volume, or even earlier when the user releases their grip from the safety lever 46, the spring 50 causes the firing pin 48 to push against the safety lever 46, which is no longer held in position by the pull pin 42 or by the user, and urge the safety lever 46 away from its position on the casing 12. The firing pin 48 thus rotates, under force of spring 50, to impact the primer 38 causing ignition of the delay column 36. The delay column 36 is effective to delay the ignition of the igniter material 34, with this delay enabling the fire extinguisher 10 to reach the fire.

After the delay column 36 finishes burning, the igniter material 34 ignites causing combustion of the aerosol-forming compound 20 leading to generation of the fire suppression agent and its discharge through the discharge ports 18. The casing 12 remains intact after all of the fire suppression agent has been generated and discharged through the discharge ports 18.

Since the fire suppression agent is discharged through the discharge ports 18 in both end walls 16, substantially no net thrust is produced which would cause movement of the casing 12 in one direction or the other (assuming the thrust produced by the discharge of the fire suppression agent through the discharge ports 18 in both end walls 16 is substantially equal).

Moreover, even if the casing 12 is introduced into a fire with one end wall 16 facing a wall defining the enclosed volume, discharge of the fire suppression agent is not entirely inhibited by the wall defining the enclosed volume, since the fire suppression agent can be discharged through the discharge ports 18 in the opposite, uninhibited end wall 16.

As discussed above, a pre-determined time delay between the release of the safety lever 46 discharge of the fire suppression agent resulting from ignition of the igniter material 34 is provided by the delay column 36, with the time of the delay being determined by appropriate design and construction thereof. Additional time delays could be provided by appropriate design and construction of the primer 38, the igniter material 34 and/or the aerosol-forming compound 20. Such a time delay is important to allow for the time needed between the time of actuation and introduction of the fire extinguisher 10 into the fire and time for the person who actuates the fire extinguisher 10 to get to a safe distance from the fire.

The combination of the igniter material 34, delay column 36, primer 38, pull pin 42 and safety lever 46 can be considered the fuse of the aerosol fire extinguisher. An alternative fuse for use in the invention incorporates an additional safety mechanism to ensure adequate time to safely release the aerosol fire extinguisher 10, such as a sliding safety latch which must be moved prior to releasing the safety lever 46.

The pull pin 42 and safety lever 46 may be constructed to cooperate such that the pull pin 42 can be released only when the safety lever 46 is urged against the casing 12. The pull pin 42 can also be constructed so that it must be turned and/or rotated before it can be released and/or pulled. This would prevent inadvertent release of the pull pin 42 and thus avoid unwanted activation of the aerosol fire extinguisher 10. Other variations in the manual activation system 40 are envisioned, for example, variations in the construction of the pull pin 42, safety lever 46, firing pin 48 and spring 50, and such variations may be derived from conventional grenade-type devices, such as munitions.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention. For example, although the described embodiments include at least one block of oxidation material and/or cooling material downstream of the aerosol-forming compound, it is also possible to provide separate blocks of oxidation material and/or cooling material with a reaction chamber therebetween, and alternatively, to eliminate these types of materials and cool the aerosol-forming compound by misdirection of the aerosol through an exit path causing a heat exchange.

1. An apparatus for extinguishing a fire, comprising:
an elongated casing having opposed end walls and at least one discharge port formed in each end wall;
generating means arranged in said casing for generating an aerosol fire suppression agent to be discharged through said at least one discharge port in each of said end walls; and
manual activation means for enabling manual activation of said generating means at a relatively safe location a distance from the fire whereby said casing is introducible into the fire upon the manual activation of said generating means.

2. The apparatus of claim 1, wherein said generating means comprise an aerosol-forming compound and igniter material arranged in connection with said aerosol-forming compound such that ignition of said igniter material causes combustion of said aerosol-forming compound thereby initiating generation of the aerosol fire suppression agent, said manual activation means being arranged to ignite said igniter material.

3. The apparatus of claim 2, wherein said activation means comprises a firing pin which causes ignition of said igniter material upon contact with a primer thereof.

4. The apparatus of claim 3, wherein said activation means further comprises a time delay column arranged between said primer and said igniter material for causing a delay in the ignition of said igniter material after said firing pin contacts said primer.

5. The apparatus of claim 3, wherein said activation means further comprises restraining means for restraining said firing pin from contacting said primer and a manually releasable pull pin arranged to maintain said restraining means in a position in which said firing pin is prevented from contacting said primer, said pull pin being releasable to allow said restraining means to be urged out of said position such that said firing pin is then movable into contact with said primer.

6. The apparatus of claim 5, wherein said activation means further comprises biasing means for biasing said firing pin against said restraining means and into contact with said primer.

7. The apparatus of claim 5, wherein said restraining means comprises a safety lever having a first part arranged alongside a lateral wall of said casing and a second part arranged above one of said end walls of said casing.

8. The apparatus of claim 3, wherein said igniter material extends at least partially into a channel formed in said aerosol-forming compound.

9. The apparatus of claim 3, further comprising a mounting projection arranged on said casing, said igniter material extending through said mounting projection and said firing pin being movably mounted to said mounting projection.

10. The apparatus of claim 1, wherein said activation means incorporates a time delay between an initial activation stage of said activation means and subsequent activation of said generating means.

11. The apparatus of claim 1, wherein said generating means comprise:
an aerosol-forming compound spaced from both of said end walls of said casing;
a first block of oxidation and/or cooling material arranged between said aerosol-forming compound and a first one of said end walls; and
a second block of oxidation and/or cooling material arranged between said aerosol-forming compound and a second one of said end walls.

12. The apparatus of claim 11, further comprising spacers for spacing said first and second blocks of oxidation and/or cooling material from said aerosol-forming compound and from said first and second end walls.

13. The apparatus of claim 11, wherein each of said first and second blocks of oxidation and/or cooling material includes a spark arresting material which prevents flame from being emitted through said at least one discharge port in each of said end walls.

14. An apparatus for extinguishing a fire, comprising:
an elongated casing having opposed end walls, at least one discharge port formed in each of said end walls, and materials designed to generate aerosol fire suppression agent which is discharged through said at least one discharge port in each of said end walls; and
a manual activation system arranged to initiate generation of the aerosol fire suppression agent by said materials at a relatively safe location a distance from the fire, said manual activation system including a manually releasable pull pin which allows generation of the aerosol fire suppression agent upon its release.

15. The apparatus of claim 14, wherein said materials include an aerosol-forming compound and igniter material arranged in connection with said aerosol-forming compound such that ignition of said igniter material causes combustion of said aerosol-forming compound thereby initiating generation of the aerosol fire suppression agent, said activation system being arranged to ignite said igniter material and including a time delay column arranged to delay combustion of said aerosol-forming compound after release of said pull pin.

16. The apparatus of claim 15, wherein said activation system further comprises a firing pin which causes ignition of said igniter material upon contact with a primer thereof and a safety lever for restraining said firing pin from contacting said primer, said delay column being arranged between said primer and said igniter material, said pull pin being arranged to maintain said safety lever in a position in which said firing pin is prevented from contacting said primer and being releasable to allow said safety lever to be urged out of said position such that said firing pin is then movable into contact with said primer.

17. The apparatus of claim 14, wherein said materials include an aerosol-forming compound spaced from both of said end walls of said casing, a first block of oxidation and/or cooling material arranged between said aerosol-forming compound and a first one of said end walls, and a second block of oxidation and/or cooling material arranged between said aerosol-forming compound and a second one of said end walls.

18. A method for extinguishing a fire, comprising:
arranging materials which generate aerosol fire suppression agent in an elongate casing having opposed end walls and at least one discharge port formed in each end wall through which the aerosol fire suppression agent is discharged from the casing, the materials including an aerosol-forming compound and igniter material in contact with the aerosol-forming compound;
biasing a firing pin into a position in which it contacts a primer for the igniter material to cause ignition thereof which in turns causes combustion of the aerosol-forming compound;
arranging a pull pin in a position in which it prevents contact between the firing pin and the primer;
in the presence of the fire, removing the pull pin from its position to thereby enable contact between the firing pin and the primer; and
introducing the casing into a fire to cause discharge of the aerosol fire suppression agent.

19. The method of claim 18, further comprising arranging a time delay column between the primer and the igniter material to cause a delay in ignition of the igniter material after contact between the firing pin and the primer.

20. The method of claim 18, further comprising:
positioning a safety lever to prevent contact between the firing pin and the primer; and
positioning the pull pin to restrain the safety lever on the casing.
